(19) United States
(12) Patent Application Publication
(10) Pub. No.: US 2019/0385052 A1
(43) Pub. Date: Dec. 19, 2019

(54) METHODS FOR DEEP LEARNING OPTIMIZATION

(71) Applicant: Deep Insight Solutions, Inc., Nashville, TN (US)

(72) Inventors: David W. Bauer, JR., Leesburg, VA (US); Christopher D. Carothers, Schenectady, NY (US)

(21) Appl. No.: 16/010,083

(22) Filed: Jun. 15, 2018

(51) Int. Cl. G06N 3/08

(52) U.S. Cl. CPC G06N 3/08

(57) ABSTRACT

A computer-implemented method is disclosed. The method may include generating a first deep learning model configuration and calculating a first result metric for the first deep learning model configuration. The method may include selecting a first sample space based on the first deep learning model configuration. The method may include generating a second deep learning model configuration. The second deep learning model configuration may be within the first sample space. The method may include calculating a second result metric for the second deep learning model configuration. The method may include, in response to the second result metric exceeding the first result metric, selecting a second sample space. The second sample space may be based on the second deep learning model configuration. The method may include, in response to the second result metric not exceeding the first result metric, reducing the size of the first sample space.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to computerized deep learning, and more particularly to deep learning optimization. Deep learning models are adept at solving a wide number of problems such as speech recognition or image classification. However, for a deep learning model configuration to be effective, its parameters should be configured correctly. One way to configuring a deep learning model configuration includes training the deep learning model configuration. However, training a deep learning model is a computationally intense process that may take a long time. While some time may be saved by setting up an initial configuration for the deep learning model configuration, there can be thousands or even millions of possible initial configurations. While some configurations can be eliminated using data science techniques, possibly millions of other configurations may remain. What is needed is a way to optimize a deep learning model configuration.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure may include a computer-implemented method. The method may include generating a first deep learning model configuration. The method may include calculating a first result metric for the first deep learning model configuration. The method may include selecting a first sample space. The first sample space may be based on the first deep learning model configuration. The method may include generating a second deep learning model configuration. The second deep learning model configuration may be within the first sample space. The method may include calculating a second result metric for the second deep learning model configuration. The method may include, in response to the second result metric exceeding the first result metric, selecting a second sample space. The second sample space may be based on the second deep learning model configuration. The method may include, in response to the second result metric not exceeding the first result metric, reducing the size of the first sample space.

Another aspect of the disclosure may include a computer-implemented method. The method may include generating a plurality of first deep learning model configurations. The method may include calculating a first result metric for each of the plurality of first deep learning model configurations. The method may include selecting a deep learning model configuration from the plurality of first deep learning model configurations. The method may include selecting a first sample space. The first sample space may be based on the selected first deep learning model configuration. The method may include generating a plurality of second deep learning model configurations. Each second deep learning model configuration may be within the first sample space. The method may include calculating a second result metric for each second deep learning model configuration. The method may include, in response to a second result metric exceeding the first result metric, selecting a second sample space. The second sample space may be based on the second deep learning model configuration corresponding to the second result metric that exceeds the first result metric. The method may include, in response to no result metric exceeding the first result metric, reducing the size of the first sample space.

One aspect of the disclosure may include a computer-implemented method. The method may include receiving a first deep learning model configuration. The method may include calculating a first result metric for the first deep learning model configuration. The method may include selecting a first sample space. The first sample space may be based on the first deep learning model configuration. The method may include generating a second deep learning model configuration. The second deep learning model configuration may be within the first sample space. The method may include calculating a second result metric for the second deep learning model configuration. The method may include, in response to the second result metric exceeding the first result metric, selecting a second sample space. The second sample space may be based on the second deep learning model configuration. The method may include, in response to the second result metric not exceeding the first result metric, reducing the size of the first sample space.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a flowchart block diagram illustrating one embodiment of a method for deep learning optimization.

FIG. 2A is a schematic block diagram illustrating one embodiment of a hyperparameter design space for deep learning optimization.

FIG. 2B is a schematic block diagram illustrating one embodiment of a hyperparameter design space for deep learning optimization.

FIG. 2C is a schematic block diagram illustrating one embodiment of a hyperparameter design space for deep learning optimization.

FIG. 2D is a schematic block diagram illustrating one embodiment of a hyperparameter design space for deep learning optimization.

FIG. 2E is a schematic block diagram illustrating one embodiment of a hyperparameter design space for deep learning optimization.

FIG. 3 is a flowchart block diagram illustrating one embodiment of a method for deep learning optimization.

FIG. 4A is a schematic block diagram illustrating one embodiment of a hyperparameter design space for deep learning optimization.

FIG. 4B is a schematic block diagram illustrating one embodiment of a hyperparameter design space for deep learning optimization.

FIG. 4C is a schematic block diagram illustrating one embodiment of a hyperparameter design space for deep learning optimization.

FIG. 4D is a schematic block diagram illustrating one embodiment of a hyperparameter design space for deep learning optimization.

FIG. 4E is a schematic block diagram illustrating one embodiment of a hyperparameter design space for deep learning optimization.

FIG. 5 is a flowchart block diagram illustrating one embodiment of a method for deep learning optimization.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “or” does not imply mutual exclusivity unless otherwise specified. The term “based on” means “based on, at least in part.”

Furthermore, the described features, structures, or characteristics of the disclosure may be combined in any suitable manner in one or more embodiments. In the following description, numerous specific details are provided, such as examples of programming, software, user selections, hardware, hardware circuits, hardware chips, or the like, to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

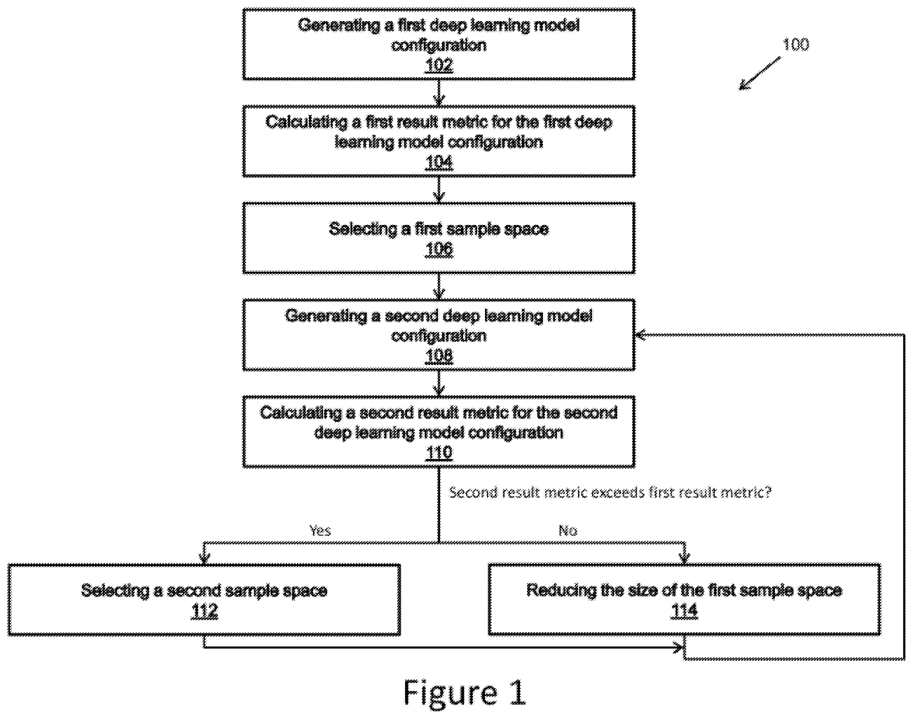

FIG. 1 depicts one embodiment of a method 100. The method 100 may include a computer-implemented method. The method 100 may include a method for optimizing a deep learning model configuration based on Random Recursive Search (RRS). As used herein, a “deep learning model” may mean a class of deep learning systems, algorithms, models, or the like. A deep learning model may include one or more parameters. The parameters may include a variety of ways to be configured. As used herein, a “parameter” of a deep learning model may mean a parameter, input feature, configuration, or the like that can be changed, and the behavior of the deep learning model may change based on the changed parameter. Each deep learning model may include one or more parameters, and the details of a parameter may depend on the type of deep learning model. As used herein, a “deep learning model configuration” may mean an instance of a deep learning model. The deep learning model configuration may include one or more parameters of the deep learning model being configured with a value or the like. In some embodiments, a deep learning model configuration may receive data as input (i.e. input data), process the input data based on the deep learning model configuration's parameters, and produce an output, such as a classification, prediction, value, or the like.

In one embodiment, a deep learning model may include a hyperparameter design space. As used herein, the “hyperparameter design space” may include one or more parameters of the deep learning model and the possible values for each of those parameters. The hyperparameter design space may include all the parameters of the deep learning model or a subset of all of the parameters. Which parameters of the deep learning model may be included in the hyperparameter design space may be based on user configuration.

As an example, in one embodiment, a deep learning model may include an artificial neural network (ANN). The ANN may include a variety of parameters. For example, a parameter of the ANN may include a weight of an edge of the ANN, a position of an edge of the ANN, a number of nodes in the ANN, the number of nodes in a layer of the ANN, the number of layers of the ANN, or the like. In one embodiment, the hyperparameter design space of the ANN may include the edge positions and the edge weights of the ANN. Thus, in this example, the hyperparameter design space of the ANN may not include the number of nodes, the number of nodes in a layer, or the number of layers in the ANN. The values of these parameters may be set and may not change during the optimization of the deep learning model. In one embodiment, a deep learning model configuration may include a specific instance of the ANN.

In some embodiments, a deep learning model configuration may include a machine learning model configuration capable of deep learning. A deep learning model may include an artificial neural network. An ANN may include a deep belief network, recurrent neural network (RNN), convolutional neural network (CNN), or the like. A deep learning model may include an estimator. A deep learning model may include other machine learning models capable of deep learning. Although the methods discussed herein refer to deep learning models, in some embodiments, the methods may be applied to a machine learning model other than a deep learning model.

In some embodiments, a deep learning model may include an ensemble of deep learning models. An ensemble may include two or more deep learning models. The two or more deep learning models may be connected in a variety of ways. In one embodiment, a parameter of an ensemble may include a type of deep learning model included in the ensemble, a position of a deep learning model in the ensemble, how the deep learning model is connected to another deep learning model, or the like.

In one embodiment, the method 100 may include generating 102 a first deep learning model configuration. In some embodiments, generating 102 the first deep learning model configuration may include generating a new deep learning model configuration. In another embodiment, generating 102 the first deep learning model configuration may include receiving a pre-configured deep learning model configuration. A pre-configured deep learning model configuration may include an instance of a deep learning model whose parameters have been previously configured before the start of the method 100. In some embodiments, generating 102 the first deep learning model configuration may include generating a value for a parameter of the first deep learning model configuration. Generating a value for a parameter of the first deep learning model configuration may include generating a value for each parameter in the hyperparameter design space of the deep learning model configuration. In one embodiment, generating the first deep learning model configuration by generating a value for each parameter in the hyperparameter design space may be called generating the first deep learning model from the hyperparameter design space.

In some embodiments, generating a value for a parameter may include determining the possible values for the parameter. Determining the possible values may include a user selecting the possible values, a range of possible values, or the like. Determining the possible values for a parameter may include determining the possible values for multiple parameters of a same type. For example, in response to the deep learning model configuration including an ANN, determining the possible values for a weight of the ANN may include determining the possible values for all the weights of the ANN. A user may select that a value of a weight in the ANN may have a value of 0 to 400, and in response, all the weights may have a possible value of 0 to 400.

In one embodiment, generating 102 the first deep learning model configuration may include generating the deep learning model configuration based on random number generation. Generating the deep learning model configuration based on random number generation may include randomly generating a parameter of the deep learning model configuration. The random generation of a parameter may include randomly selecting a value for the parameter from all possible values of the parameter, a subset of all possible values of the parameter, or the like. For example, the deep learning model configuration may include an ANN. Generating the ANN based on random number generation may include randomly generating a weight of an edge, randomly generating the position of an edge, randomly generating the number of nodes in the ANN, randomly generating the number of layers of the ANN, randomly generating which nodes belong to which layers, or the like. In some embodiments, randomly generating deep learning model configurations may be quicker at finding a deep learning model configuration that performs better at solving a problem than using some learning algorithms, such as backpropagation or the like. This may occur because learning algorithms can be slow compared to random generation of parameters. Furthermore, certain learning algorithms, like backpropagation, may seek to learn how the interaction of different parameters can lead to a better deep learning model configuration. This learning may be slow compared to randomly generating parameters and testing if the configuration of parameters leads to better results. In some embodiments, randomly generating parameters may not be affected by local minima as some learning algorithms, like backpropagation, may be.

In one embodiment, generating 102 the first deep learning model configuration may include generating multiple deep learning model configurations. Generating multiple deep learning model configurations will be discussed in more detail below.

In one embodiment, the method 100 may include calculating 104 a first result metric for the first deep learning model configuration. A result metric may include a measurement of how well a deep learning model configuration is at performing its purpose. For example, the purpose of a deep learning model configuration may include image classification. A result metric for the deep learning model configuration may include an accuracy of the deep learning model configuration at classifying an image. A result metric for the deep learning model configuration may include overfit, underfit, or the like.

In one embodiment, calculating 104 the result metric may include testing the deep learning model configuration on a testing dataset. For example, in response to randomly generating an ANN, calculating 104 the result metric of the ANN may include inputting the testing dataset into the ANN and determining the accuracy, overfit, or underfit of the ANN.

In some embodiments, the result metric may include a response surface. The response surface may include multiple dimensions, and each dimension may represent a goal (e.g. accuracy, underfit, overfit, or the like). Each point in the response surface may include a certain value for each of the dimensions. In one embodiment, the goals may be competing and the deep learning model configuration doing better in one goal may simultaneously cause the deep learning model configuration to do worse in another goal. In response, the result metric may include a measurement based on the competing goals.

In one embodiment, the method 100 may include selecting 106 a first sample space. The first sample space may be based on the first deep learning model configuration. As used herein, a “sample space” may mean a subsection of the hyperparameter design space. Each dimension of the sample space may include a range of possible values for a parameter of the deep learning model configuration. The sample space may be smaller than the hyperparameter design space, thus the range of possible values for a parameter may be smaller in the sample space. In some embodiments, selecting 106 the first sample space based on the first deep learning model configuration may include selecting the first sample space based on the first deep learning model configuration having a result metric above a predetermined threshold. The predetermined threshold may include the first deep learning model configuration having a higher result metric than other deep learning model configurations.

In another embodiment, the sample space being based on the deep learning model configuration may include the sample space being centered on the deep learning model configuration. The sample space being centered on the deep learning model configuration may include the range of possible values for a dimension in the sample space having its center value be the value of the deep learning model configuration's parameter corresponding to that dimension. In some embodiments, the size of the range for each dimension may be different.

In one embodiment, the method 100 may include calculating an exploitation threshold. Calculating an exploitation threshold may include calculating the threshold based on user configuration, an average result metric, or the like. In some embodiments, selecting 106 the first sample space may include selecting the first sample space in response to the first metric exceeding the exploitation threshold. In one embodiment, a reason for having an exploitation threshold may include to prevent the method 100 from selecting deep learning model configurations with only a small increase in its result metric than the result metric of the deep learning model around which the first sample space is based. In some embodiments, it may be faster, more advantageous, or the like to generate another deep learning model configuration than to re-center, recalculate, or the like for a sample space.

In one embodiment, the method 100 may include generating 108 a second deep learning model configuration. The second deep learning model configuration may be within the first sample space. The second deep learning model configuration being within the first sample space may include the parameters of the second deep learning model configuration having values within the ranges of the dimensions of the first sample space.

In one embodiment, generating 108 the second deep learning model configuration may include generating a new deep learning model configuration with values within the first sample space. In another embodiment, generating 108 the second deep learning model configuration may include adjusting the one or more parameters of the first deep learning model configuration. In some embodiments, generating 108 the second deep learning model configuration may include generating multiple second deep learning model configurations within the first sample space, as discussed below. In one embodiment, generating the second deep learning model configuration by generating or adjusting a value for each parameter in the first sample space may be called generating the first deep learning model from the first sample space.

In one embodiment, the method 100 may include calculating 110 a second result metric for the second deep learning model configuration. Calculating 110 the second result metric may be similar to calculating 104 the first result metric.

In some embodiments, in response to the second result metric exceeding the first result metric, the method may include selecting 112 a second sample space. The second sample space may be based on the second deep learning model configuration. In some embodiments, selecting 112 the second sample space may include centering the second sample space around the second deep learning model configuration. Centering the second sample space around the second deep learning model configuration may be similar to centering the first sample space around the first deep learning model configuration. In some embodiments, the second sample space may be the same size as the first sample space. In another embodiment, the second sample space may be larger or smaller than the first sample space.

In some embodiments, the second result metric exceeding the first result metric may include the second result metric exceeding the first result metric by a threshold amount. The threshold amount may include an amount based on user configuration. For example, a user configuration may include selecting the second sample space in response to the second result metric exceeding the result metric by 0.00001. Thus, in response to the first result metric being 87.665435623 and the second result metric being 87.665435625, the second result metric does not exceed the first result metric by 0.00001 and the second deep learning model configuration will not be selected to be the center of the second sample space. In one embodiment, a reason for having the threshold may include to prevent the method 100 from selecting deep learning model configurations with only a small increase in its result metric than another result metric. In some embodiments, it may be faster, more advantageous, or the like to generate another deep learning model configuration than to re-center, recalculate, or the like a sample space.

It should be noted that one result metric exceeding another result metric may not necessarily include one result metric having a higher value than the other. In some embodiments, the second result metric exceeding the first result metric may include that the deep learning model configuration corresponding to the second metric performs better than the deep learning model configuration corresponding to the first result metric. For example, in one embodiment, a result metric may include number of misclassifications. Thus, the lower the number of misclassifications, the better the deep learning model configuration. Thus, in some embodiments, a result metric exceeding another result metric may include a result metric being lower than another result metric.

In another embodiment, in response to the second result metric not exceeding the first result metric, the method 100 may include reducing 114 the size of the first sample space. Reducing 114 the size of the first sample space may include reducing the range of possible values for one or more parameters of the first deep learning model configuration. In some embodiments, the first sample space may continue to be centered around the first deep learning model configuration.

In some embodiments, reducing the size of the first sample space may assist in finding another deep learning model configuration with a higher result metric than the first deep learning model configuration. This may be because the method 100 is searching in a smaller area, and thus, has a higher likelihood of finding something better within that area.

In some embodiments, in response to either selecting the second sample space or reducing the size of the first sample space, the method 100 may include generating a third deep learning model configuration within the new sample space (i.e. the second sample space or the reduced first sample space) and continuing the search process. Thus, the method 100 may return to step 108 and use another deep learning model configuration to continue searching for a deep learning model configuration with a higher result metric as depicted in FIG. 1. The method 100 may repeat until stopping criteria is met.

In one embodiment, a stopping criteria may include not finding deep learning model configuration with a corresponding result metric with an improvement over a current best result metric. A stopping criteria may include not finding a deep learning model configuration with a corresponding result metric with an improvement over a certain threshold. A stopping criteria may include adjusting the threshold after a predetermined number of deep learning model configurations have been generated. In some embodiments, in response to meeting the stopping criteria, the method 100 may include selecting the deep learning model configuration with the highest result metric as the output deep learning model configuration. In response to selecting the output deep learning model configuration, the method 100 may cease. The method 100 ceasing may include the method 100 ceasing temporarily.

In some embodiments, the output deep learning model configuration may perform well on input data that it has not encountered previously. However, the output deep learning model configuration may encounter a set of input data that may be significantly different from the input data the output deep learning model configuration may have used previously or encountered as testing data. In response, the output deep learning model configuration may be less accurate or perform worse on this new set of input data. Thus, in one embodiment, further optimization may assist the output deep learning model configuration to perform well on the new set of input data.

In an embodiment, the method 100 may include calculating a threshold result metric. A result metric of a deep learning model configuration below the threshold result metric may indicate that the deep learning model configuration may benefit from further optimization. The method 100 may include calculating a third result metric. The third result metric may be for the output deep learning model configuration. The third result metric may be based on additional training set data. Calculating the third result metric may be similar to calculating 104 the first result metric. The method 100 may include, in response to determining that the third result metric is below the threshold result metric, selecting a third sample space. The third sample space may be based on the output deep learning model configuration. Selecting the third sample space may be similar to selecting 106 the first sample space. In one embodiment, the method 100 may include continuing one or more steps of the method 100 until a stopping criteria is met and a new output deep learning model configuration is selected.

In an embodiment, it may be beneficial to generate some deep learning model configurations using different computational approaches. Determining which computational approach may be used may be based on the level of the hyperparameter design space the deep learning model configuration is being generated from, a capability of a computational approach, or the like. In one embodiment, generating a deep learning model configuration at a higher level may include using a first computational approach, and generating a deep learning model configuration at a lower level may include using a second computational approach.

As used herein, a “level” of the hyperparameter design space may include the hyperparameter design space itself, or a subsection of the hyperparameter design space. A level may be higher, lower, or at the same level as another level. In some embodiments, whether a level is higher or lower than another level may be based on a size of the level. For example, a higher level may include a larger size in the hyperparameter space than a lower level, with the hyperparameter design space itself being the highest level. The hyperparameter design space may include a first level, the first sample space may include a second level that is lower than the first level, and the reduced first sample space may include a third level lower than the second level. The examples herein of higher or lower levels of the hyperparameter design space are only for illustrative purposes.

In some embodiments, a computational approach may include software. The software may include a software library, e.g. a dataflow programming library or the like. A computational approach may include an algorithm or the like (e.g. an algorithm that approximates, an algorithm that produces an accurate output, or the like). In another embodiment, a computational approach may include computer hardware, e.g. a central processing unit (CPU), a graphics processing unit (GPU), an application-specific integrated circuit (ASIC), or the like. In some embodiments, a computational approach may include a portion of software (e.g. a function, subroutine, or the like) or a portion of hardware. A computational approach may include a hardware representation (e.g. a 16 bit integer data type, a 64 bit floating point data type, or the like). Some computational approaches may include different capabilities such as speed, accuracy, memory usage, storage usage, network usage, or the like.

In one embodiment, when generating a deep learning model configuration from a higher level of the hyperparameter design space, it may be beneficial to generate the deep learning model configuration quickly. This may be because, initially, it may be more advantageous to generate several deep learning model configurations to increase the probability of generating a deep learning model configuration that may yield a high result metric. In response, generating a deep learning model configuration using a computational approach that may include a lower accuracy capability, but a high speed capability may be advantageous. However, at a lower level of the hyperparameter design space (such as the first sample space, the reduced first sample space, a second reduced sample space, or the like), computational accuracy may be more beneficial than speed. In response, generating a deep learning model configuration using a computational approach that may include a high accuracy capability may be advantageous.

In one embodiment, generating 102 the first deep learning model configuration may include generating the first deep learning model using a first computational approach. Generating 108 the second deep learning model configuration may include generating the second deep learning model using a second computational approach. In one embodiment, the first computational approach may include a higher speed capability than the second computational approach. In another embodiment, the second computational approach may include a higher accuracy capability than the first computational approach.

For example, in some embodiments, a GPU may include a high speed capability, but may not include, compared to a CPU, a high accuracy capability. A CPU may include a high accuracy capability, but may not include, compared to a GPU, a high speed capability. In response, generating 102 the first deep learning model configuration may include using a GPU to generate the first deep learning model configuration. In response, generating 102 the first deep learning model configuration may include generating the first deep learning model configuration quickly in order to find an initial first sample space that is likely to yield a good search area in the hyperparameter design space. Generating 108 the second deep learning model configuration may include using a CPU to generate the second deep learning model configuration. In response, generating 108 the second deep learning model configuration may include generating the second deep learning model configuration using more accurate calculations.

In some embodiments, the method 100 may be balancing improving the deep learning model configuration with computing resources (e.g. processor consumption, memory consumption, non-volatile storage consumption, power consumption, computing time, or the like). Initially, improvements to the deep learning model may be worth the computing resources, but as the rate of improvement slows, it may be more advantageous to stop searching for a better deep learning model configuration than to expending a large amount of computing resources to find a small improvement.

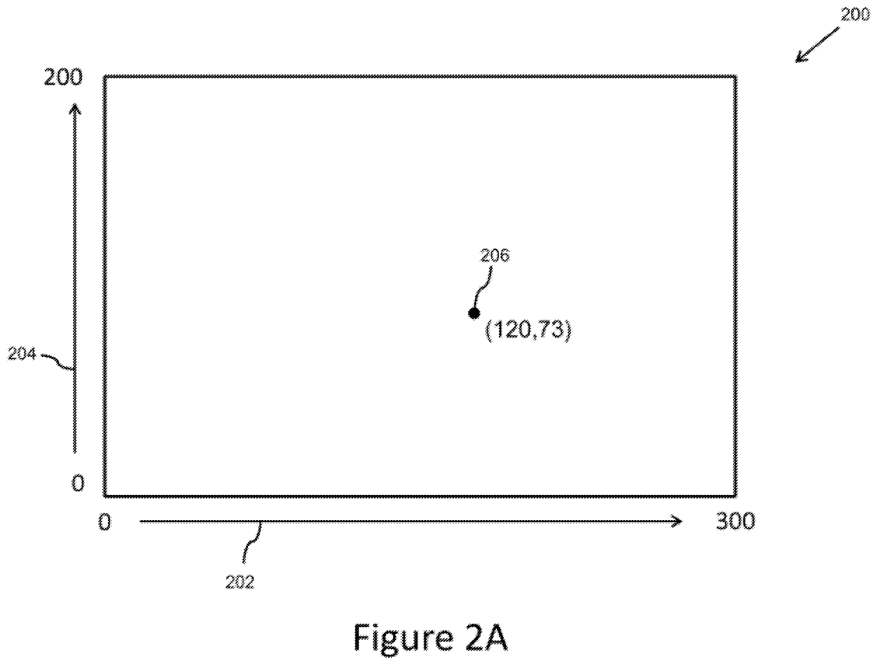

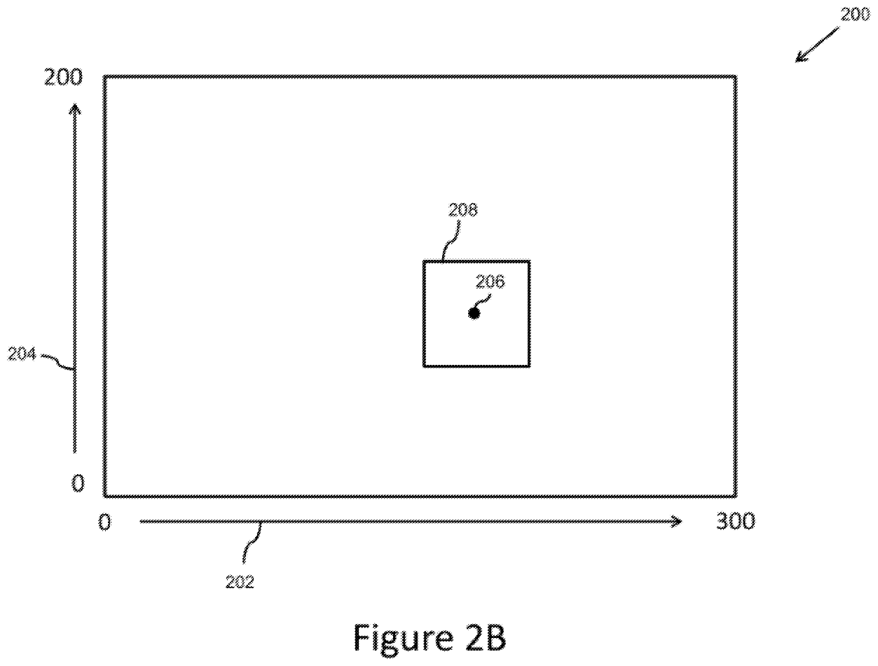

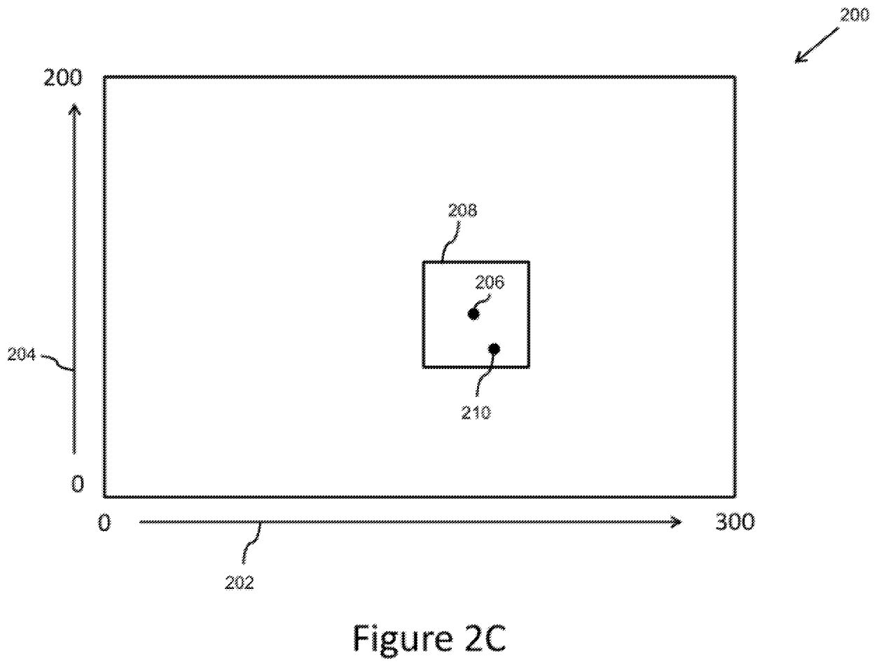

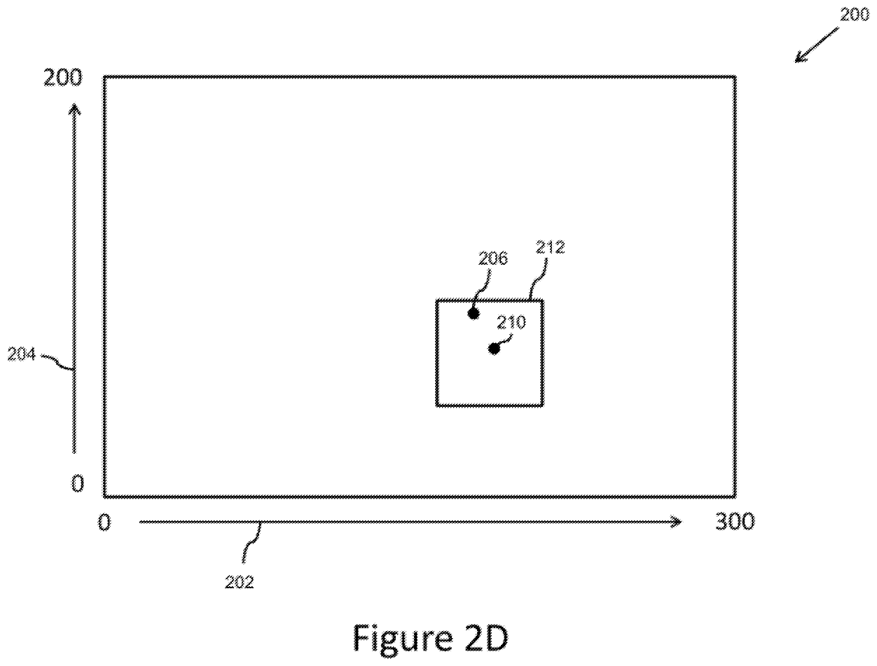

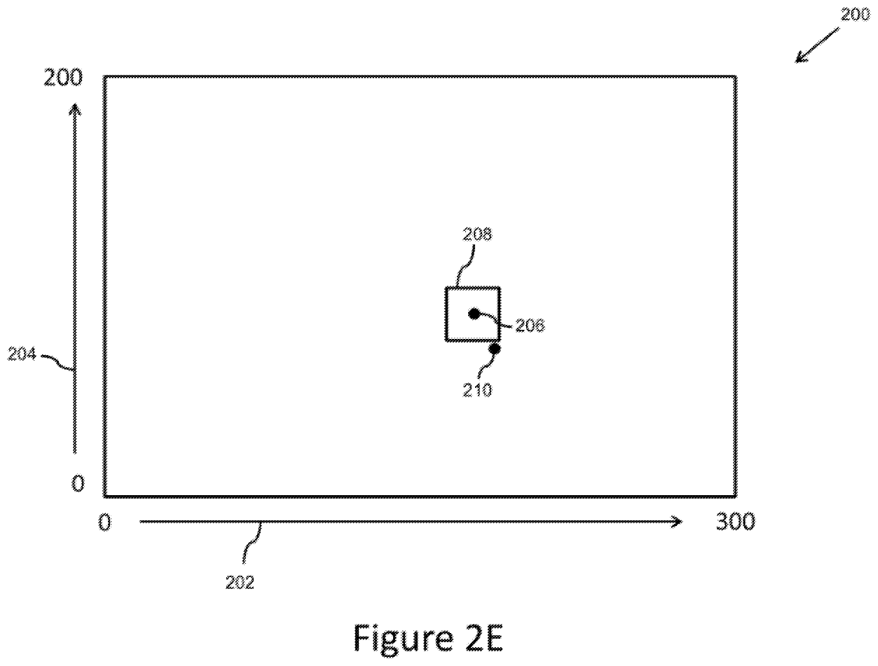

FIG. 2A depicts one embodiment of a representation of a hyperparameter design space 200. The hyperparameter design space 200 may include one or more dimensions and each dimension may include a parameter of the first deep learning model configuration. A dimension may include the range of all possible values for the parameter. For example, as shown in FIG. 2A, a hyperparameter design space 200 may include a first dimension 202 and a second dimension 204. The first dimension 202 may correspond to a first parameter of a deep learning model configuration and the second dimension may correspond to a second parameter of the deep learning model configuration. The first parameter may have a range of possible values from 0 to 300 and the second parameter may have a range of possible values from 0 to 200. The hyperparameter design space 200 may include a point 206. The point 206 may correspond to a deep learning model configuration. FIG. 2A may include the result of generating 102 a first deep learning model configuration of method 100. In FIG. 2A, the point may correspond to a deep learning model configuration whose first parameter has a value of 120 and whose second parameter has a value of 73.

It should be noted that FIG. 2A, for illustrative purposes, depicts a very simple hyperparameter design space 200. For many deep learning model configurations, these configurations may include thousands of parameters. For example, as discussed above regarding an ANN, a hyperparameter design space 200 may include a dimension for each weight of an edge, a dimension for each edge position, a dimensions for a number of nodes, or the like. Thus, a visual representation of a hyperparameter design space for such configuration would likely be impossible.

FIG. 2B depicts one example of a hyperparameter design space 200. The hyperparameter design space 200 may include one embodiment of the result of selecting 106 a first sample space of the method 100. For example, the hyperparameter design space 200 may include a first sample space 208. The first sample space 208 may be smaller than the hyperparameter design space 200. The first sample space 208 may be centered on the point 206. For example, the point 206 corresponding to the first deep learning model configuration may have values for the first dimension 202 and the second dimensions 204 of 45 and 73 respectively. The range of the first sample space for each dimension may include 50 possible values. Thus, in response to the range being 50 possible values and the center being at (120,73), the ranges of possible values for the first and second parameters in the first sample space are 95 to 145 and 48 to 98 respectively.

FIG. 2C depicts one embodiment of a hyperparameter design space 200. FIG. 2C may depict one embodiment of the result of generating 108 a second deep learning model configuration of the method 100. In response to the first sample space 208 having a range of 50 values in each dimension centered around the values 120 and 73, the second deep learning model configuration's first and second parameters may be 132 and 55 respectively. This may correspond to a second point 210 in the hyperparameter design space 200.

FIG. 2D depicts one embodiment of a hyperparameter design space 200. FIG. 2D may depict one embodiment of the result of selecting 112 a second sample space of the method 100. For example, in response to the second result metric of the second point 210 exceeding the result metric of the first point 206, the method 100 may include selecting 112 a second sample space 212 centered around the second point 210.

FIG. 2E depicts one embodiment of a hyperparameter design space 200. FIG. 2E may depict one embodiment of the result of reducing 114 the size of the first sample space. For example, as depicted in FIG. 2E, in response to the result metric of the second deep learning model configuration that corresponds to the second point 210 not exceeding the first result metric, the range of possible values for the parameters, represented by the first sample space 208, may be reduced from 50 values to 30 values. Thus, the range of possible values for the first and second parameters would still be centered around 120 and 73, but the possible values would be 105 to 135 and 58 to 88.

In one embodiment, the hyperparameter design space 200 may include a first level of the hyperparameter design space. Generating 102 the first deep learning model configuration may include using a first computational approach. For example, the computation approach may include a high speed capability. The first sample space 208 may include a second level. The second level may be lower than the first level. Generating 108 the second deep learning model configuration may include using a second computational approach. The second computational approach may include a lower speed capability than the first computational approach, but a higher accuracy capability. The reduced first sample space 208 of FIG. 2E may include a third level. The third level may be lower than the second level. Generating a third deep learning model configuration from the reduced first sample space 208 may include using a third computational approach. The third computational approach may include a higher accuracy capability than the second computational approach.

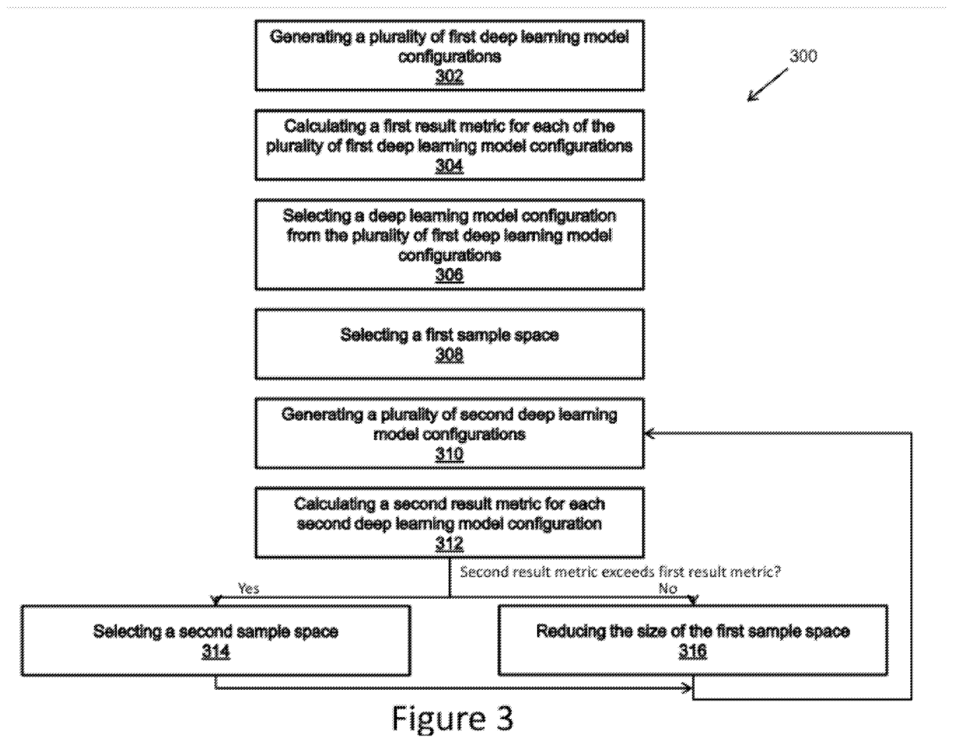

FIG. 3 depicts one embodiment of a method 300. The method 300 may include generating 302 a plurality of first deep learning model configurations. Generating 302 a plurality of first deep learning model configurations may be similar to generating 102 a first deep learning model configuration of the method 100 as described above. In one embodiment, generating 302 the plurality of first deep learning model configurations may include generating a predetermined number of deep learning model configurations. The predetermined number may be based on a confidence interval. The confidence interval may include a user-defined confidence interval.

In some embodiments, each of the deep learning model configurations of the plurality of first deep learning model configurations may include different values for each of its parameters. For example, generating multiple deep learning model configurations may include randomly generating two ANNs. The first ANN may include a variety of randomly generated nodes randomly grouped into layers, a variety of edges each with its own randomly generated weight and randomly connected to nodes of the ANN. The second ANN may include randomly generated nodes and edges in randomly generated positions within the ANN with different values for these parameters than the first ANN.

In another embodiment, generating 302 the plurality of first deep learning model configurations may include generating two or more of the first deep learning model configurations in parallel. Generating two or more of the first deep learning mode configurations in parallel may include using a compute cluster, supercomputer, or the like. Generating 302 the plurality of first deep learning model configurations may lend itself to generating the deep learning model configurations concurrently since each deep learning model configuration may be generated independently of the others and may not be dependent on the others.

In some embodiments, the method 300 may include calculating 304 a first result metric for each of the plurality of first deep learning model configurations. Calculating 304 a first result metric for each first deep learning model configuration may be similar to calculating 104 the first result metric for the first deep learning model configuration of method 100 as described above. In one embodiment, calculating 304 the first result metric for each of the plurality of first deep learning model configurations may include calculating two or more result metrics in parallel. Calculating two or more result metrics in parallel may include using a compute cluster, supercomputer, or the like.

In one embodiment, the method 300 may include selecting 306 a deep learning model configuration from the plurality of first deep learning model configurations. In some embodiments, selecting 306 the deep learning model configuration may include selecting the deep learning model configuration based on the result metric of the selected first deep learning model configuration. For example, selecting 306 the deep learning model configuration from the plurality of first deep learning model configurations may include selecting the deep learning model configuration with a result metric above a predetermined threshold. In one embodiment, selecting the deep learning model configuration with a result metric above the predetermined threshold may include selecting the deep learning model configuration with highest result metric of the result metrics of the plurality of first deep learning model configurations.

In another embodiment, the method 300 may include selecting 308 a first sample space. The first sample space may be based on the selected first deep learning model configuration. In some embodiments, selecting 308 the first sample space may be similar to selecting the first sample space 106 of the method 100 described above.

In some embodiments, the method 300 may include generating 310 a plurality of second deep learning model configurations. Each second deep learning model configuration may be within the first sample space. In one embodiment, generating 310 the plurality of second deep learning model configurations may include generating a predetermined number of second deep learning model configurations. The predetermined number may be based on a confidence interval. The predetermined number may include the same number of first deep learning model configurations or may include a different number. In another embodiment, 310 the plurality of second deep learning model configurations may include generating two or more of the second deep learning model configurations in parallel. Generating two or more of the second deep learning model configurations in parallel may include using a compute cluster, supercomputer, or the like.

In one embodiment, the method 300 may include calculating 312 a second result metric for each second deep learning model configurations of the plurality of second deep learning mode configurations. Calculating 312 the second result metric for each second deep learning model configuration may be similar to calculating 304 the first result metric for each first deep learning model configuration described above. In some embodiments, calculating 312 the second result metric for each second deep learning model configuration may include calculating two or more second result metrics in parallel. Calculating two or more second result metrics in parallel may include using a compute cluster, supercomputer, or the like.

In another embodiment, the method 300 may include, in response to a second result metric exceeding the first result metric, selecting 314 a second sample space. The second sample space may be based on the second deep learning model configuration corresponding to the second result metric that exceeds the first result metric. Selecting 314 the second sample space may be similar to selecting 112 a second sample space of method 100 described above.

In one embodiment, in response to no second result metric of the plurality of second deep learning model configurations exceeding the first result metric, the method 300 may include reducing 316 the size of the first sample space. In some embodiments, reducing 316 the size of the first sample space may be similar to reducing 114 the size of the first sample space of method 100 described above.

In one embodiment, generating one or more deep learning model configurations may include efficient generation of a deep learning model configuration. The efficiency may be based on random generation or the like. The generation may be more efficient than tracking parameters of a deep learning model configuration and tracking the effectiveness of certain parameters' interactions with other parameters. Furthermore, certain steps such as generating deep learning model configurations, testing the deep learning model configurations, or the like may be done in parallel using a compute cluster, supercomputer, or the like. By randomly generating deep learning model configurations and by focusing the generation around deep learning models with high result metrics, an optimized initial deep learning model configuration can be found. Furthermore, by using an existing deep learning model configuration as a basis for optimization, an even more optimized version of that deep learning model configuration may be found.

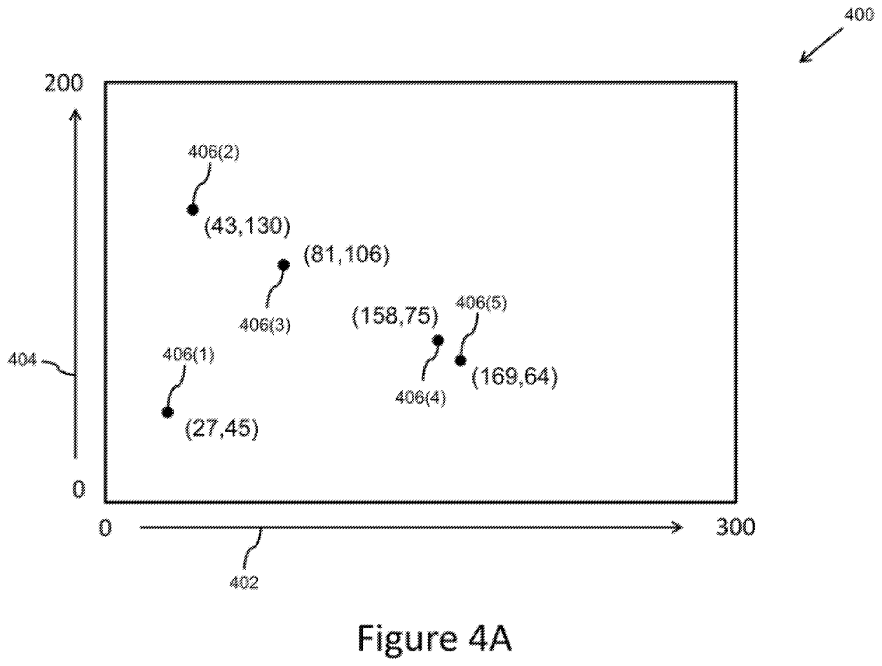

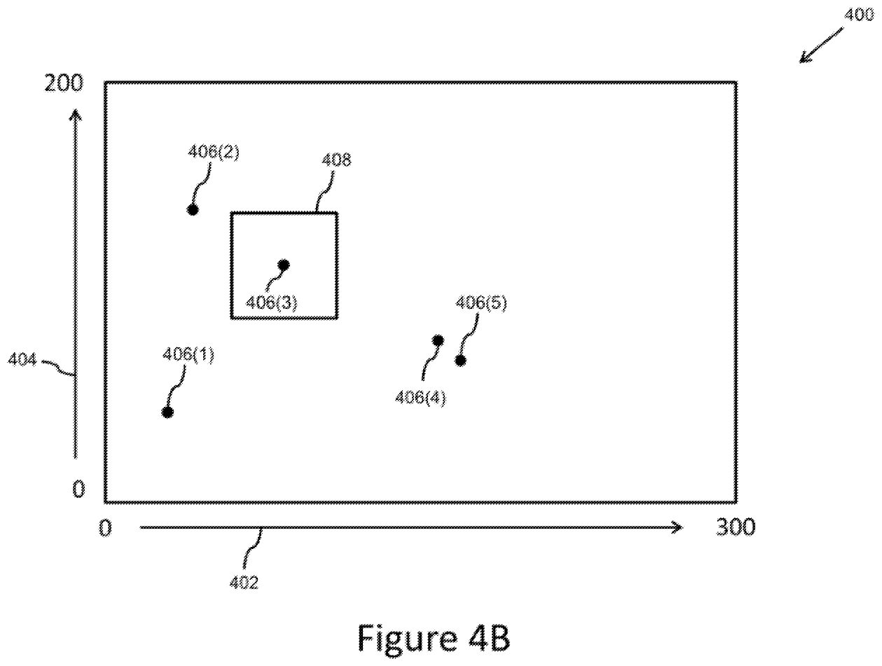

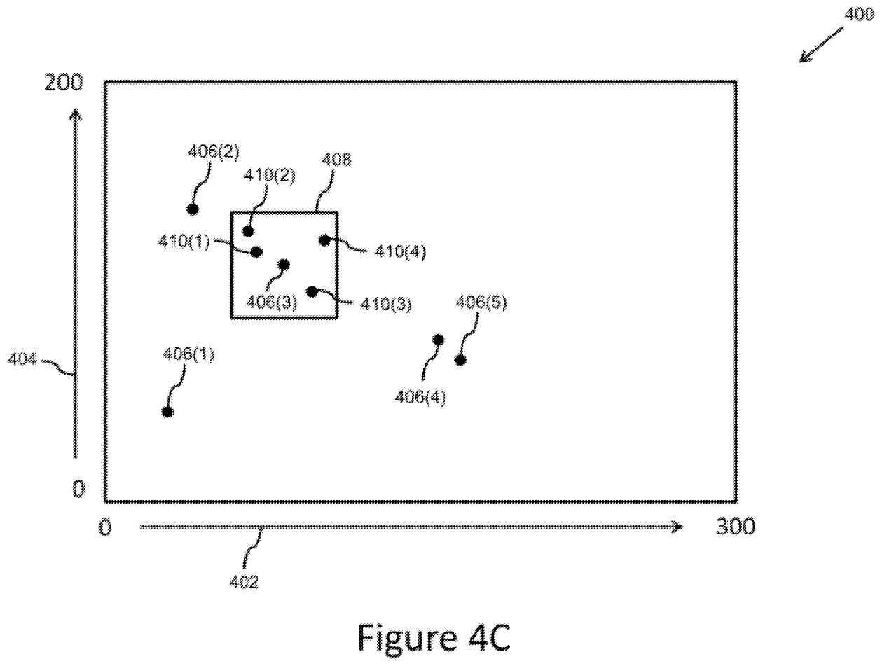

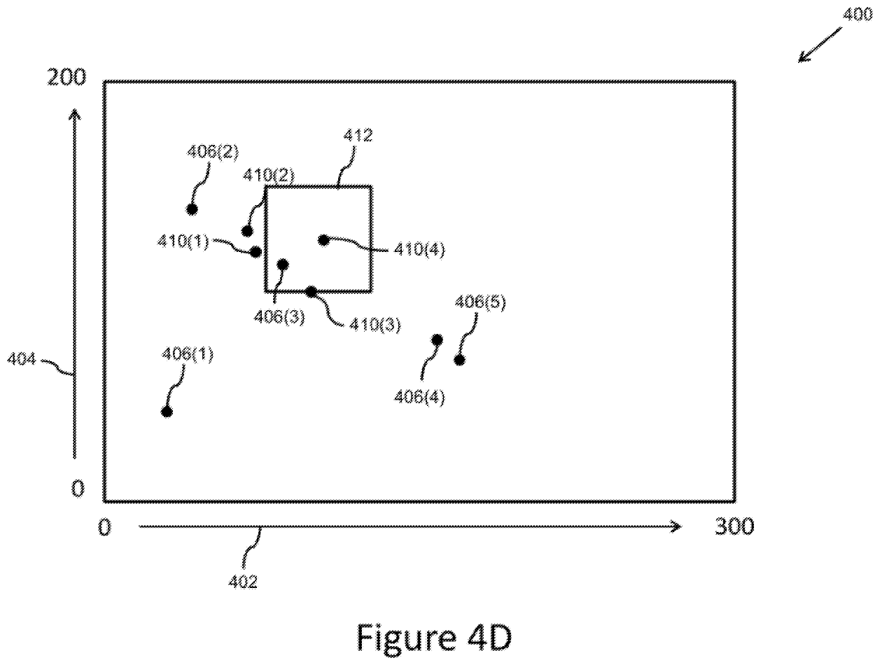

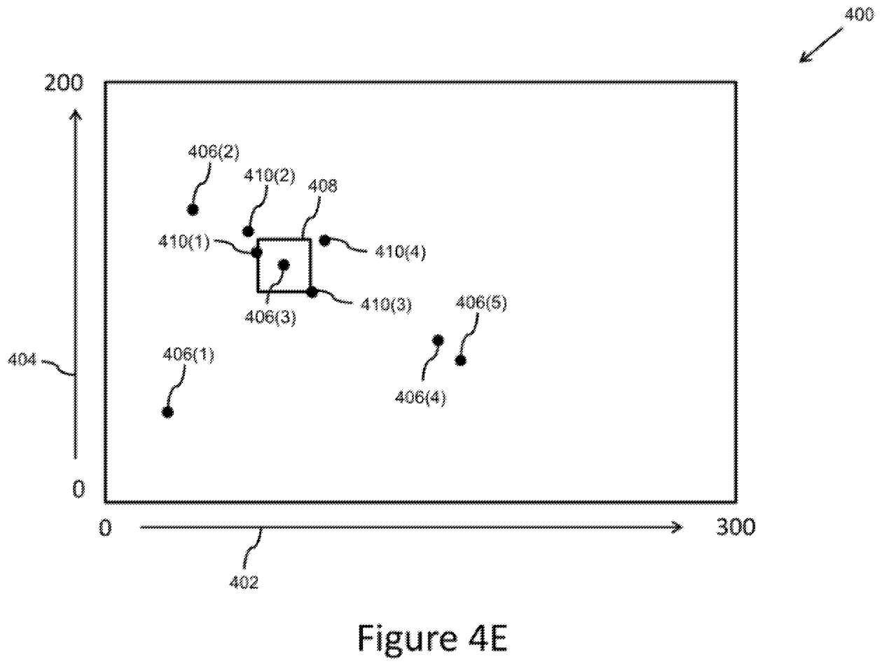

FIG. 4A depicts one embodiment of a hyperparameter design space 400. The hyperparameter design space 400 may include a hyperparameter design space similar to the hyperparameter design space 200 of FIGS. 2A-E discussed above. For example, the hyperparameter design space 400 may include a first dimension 402 and a second dimension 404 each corresponding to possible values of a parameter of a deep learning model configuration. The hyperparameter design space 400 may include a plurality of points 406(1)-(5). A point 406 may correspond to a deep learning model configuration of the plurality of first deep learning model configurations. Each first deep learning model configuration may include different values for parameters than other first deep learning model configuration as seen in FIG. 4A where each point has different values in the first dimension 402 and second dimension 404. FIG. 4A may depict the result of one embodiment of generating 302 a plurality of first deep learning model configurations. In one embodiment the result metrics for the deep learning model configurations corresponding to the points 406(1)-(5) may be 41, 36, 86, 44, and 52 respectively. In response, selecting 306 the deep learning model configuration may include selecting the deep learning model configuration corresponding to the point 406(3).

FIG. 4B depicts one embodiment of a hyperparameter design space 400. FIG. 4B may depict one embodiment of the result of selecting 308 a first sample space. For example, in response to the deep learning model configuration that corresponds to the point 406(3) having the highest result metric, the first sample space 408 may be based on the deep learning model that corresponds to the point 406(3). The first sample space 408 may be centered around the point 406(3). In some embodiments, the first sample space 408 may include other deep learning model configurations of the plurality of first deep learning model configurations.

Continuing the above example, as depicted in FIG. 4C, in one embodiment, generating 310 a plurality of second deep learning model configurations may include generating a plurality of deep learning model configurations corresponding to the points 410(1)-(4). Each of the points 410 may be within the first sample space 408. In one embodiment, calculating 312 a second result metric for each second deep learning model configuration may include calculating a result metric for each deep learning model configuration corresponding to the points 410(1)-(5). These result metrics may include, respectively, 77, 65, 85, and 92. Since 92 exceeds the result metric of the deep learning model configuration that corresponds to the point 406(3) (i.e. 86), in response, the second sample space 412 may be based on the deep learning model configuration corresponding to the point 410(4), as is depicted in FIG. 4D.

FIG. 4E depicts one embodiment of the hyperparameter design space 400. However, instead of the result metric of the deep learning model configuration corresponding to the point 410(4) being 92 as it was in the example of FIG. 4D above, the result metric for the point 410(4) may be 27. Thus, the second result metrics may include 77, 65, 85, and 27. In one embodiment of reducing 316 the size of the first sample space, in response to no result metric exceeding the first result metric (i.e. 86), the first sample space 408 may reduce in size. The first sample space 408 may remain based on the selected first deep learning model configuration corresponding to the point 406(3).

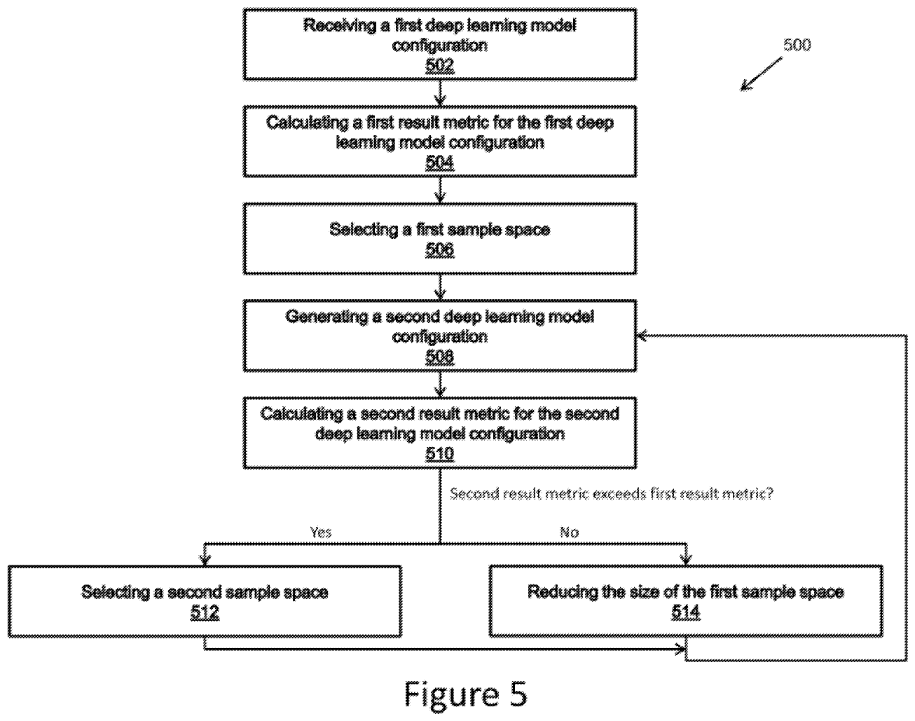

FIG. 5 depicts one embodiment of a method 500. The method 500 may include a computer-implemented method for improving a deep learning model configuration. The method 500 may include receiving 502 a first deep learning model configuration. In some embodiments, receiving 502 a first deep learning model configuration may include receiving a pre-configured deep learning model. For example, a user may have a deep learning model that has been generated through training on training data. The user may want to improve the deep learning model, but training the model on more training data may not be effective. Generating more training data may be difficult and time-consuming. Training the model on the additional training data may yield minimal increases in the results of the model. Improvements to the model may result from the model having different parameter values than it currently has, including having different parameter values for parameters that do not change during the training process. In some embodiments, since the pre-configured model may already be yielding good results, using the pre-configured model as a starting point may be helpful.

The method 500 may include calculating 504 a first result metric for the first deep learning model configuration. Calculating 504 the first result metric may be similar to calculating 104 the first result metric of the method 100 or calculating 304 a first result metric for each of a plurality of first deep learning model configurations of the method 300. In one embodiment, the method 500 may include selecting 506 a first sample space. The first sample space may be based on the first deep learning model configuration. Selecting 506 the first sample space may be similar to selecting 106 the first sample space of the method 100 or selecting 308 the first sample space of the method 300.

The method 500 may include generating 508 a second deep learning model configuration. The second deep learning configuration may be within the first sample space. Generating 508 the second deep learning model configuration may be similar to generating 108 the second deep learning model configuration of the method 100 or generating 310 a plurality of second deep learning model configurations of the method 300.

In one embodiment, generating 508 the second deep learning model configuration may include adjusting a parameter of the deep learning model configuration. Adjusting a parameter of the deep learning model may include changing the value of a parameter without generating a new deep learning model configuration. In some embodiments, it may be more efficient to change the parameters values of a deep learning model configuration than to generate a new deep learning model configuration whose parameter values are equal to the parameter values of the changed deep learning model. In one embodiment, adjusting a parameter the first deep learning model configuration may include adjusting a weight of an edge of a neural network of the first deep learning model configuration. The adjusting the weight may include adjusting the weight within a predetermined amount. The predetermined amount may include an amount based on the range of the first sample space in the dimension corresponding to the weight of that edge.

In another embodiment, adjusting a parameter the first deep learning model configuration may include adding an edge to a neural network of the first deep learning model configuration. Adding the edge may include adding a predetermined number of edges. The predetermined number may be based on the first sample space in the dimension corresponding to a number of edges. The position of an added edge may include a position based on the first sample space in the dimension corresponding to a position of an edge. In some embodiments, adjusting a parameter the first deep learning model configuration may include removing an edge from a neural network of the first deep learning model configuration. Removing the edge may include removing a predetermined number of edges. The predetermined number may be based on the first sample space in the dimension corresponding to a number of edges. The position of a removed edge may include a position based on the first sample space in the dimension corresponding to a position of an edge.

In one embodiment, the first deep learning model configuration may include an ensemble. The ensemble may include multiple learning model configurations. Adjusting a parameter of the first deep learning model configuration may include removing a learning model from the ensemble. For example, the first deep learning model configuration may include an ensemble that includes four ANNs, each ANN having a different set of parameters. The ensemble may be configured to output the majority result of the ANNs. In one embodiment, adjusting a parameter of the first deep learning model may include removing one ANN from the ensemble. Removing an ANN may include removing the ANN with the least accuracy on a testing dataset.

In one embodiment, adjusting a parameter of the first deep learning model configuration may include adding a learning model to the ensemble. For example, adding a learning model to the ensemble may include adding an ANN to the ensemble from the example above. The added ANN may include an ANN whose edge positions and edge weights are based on random generation. The parameters of the randomly generated ANN may be within the first sample space's dimensions corresponding to those parameters.

Adjusting a parameter of the first deep learning model configuration may include repositioning a learning model in the ensemble. For example, in some embodiments, an ensemble may include multiple learning models and a first learning model may feed its output into a second learning model as input. In one embodiment, repositioning a learning model in the ensemble may include positioning the second learning model to feed its output as input to the first learning model. In some embodiments, the input and output data formats or the like may adjust so that the different learning models are compatible with each other regarding input and output.

In some embodiments, the method 500 may include calculating 510 a second result metric for the second deep learning configuration. Calculating 510 the second result metric may be similar to calculating 110 the second result metric of the method 100 or calculating 312 a second result for each second deep learning model configuration of the method 300. In another embodiment, the method 500 may include, in response to the second result metric exceeding the first result metric, selecting 512 a second sample space, wherein the second sample space is based on the second deep learning model configuration. Selecting 512 the second sample space may be similar to selecting 112 the second sample space of the method 100 or selecting 314 the second sample space of the method 300. The method 500 may include, in response to the second result metric not exceeding the first result metric, reducing 514 the size of the first sample space. Reducing 514 the size of the first sample space may be similar to reducing 114 the size of the first sample space of the method 100 or reducing 316 the size of the first sample space of the method 300.

As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having program code embodied thereon.

In some embodiments, a module may be implemented as a hardware circuit comprising custom very-large-scale integration (VLSI) circuits or gate arrays, off-the-shelf semiconductors such as central processing units (CPUs), graphics processing units (GPUs), logic chips, transistors, or other discrete components. A module may also be implemented in programmable hardware devices such as field programmable gate arrays, programmable array logic, programmable logic devices or the like. A module may be implemented in a supercomputer, computer cluster, or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one embodiment, the computer readable program instructions may execute on a supercomputer, a computer cluster, or in some other distributed computing environment. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations or block diagrams of methods, apparatuses, systems, or computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present invention of new and useful methods for deep learning optimization, it is not intended that such references be construed as limitations upon the scope of this invention.

What is claimed is:

1. A computer-implemented method, comprising:
generating a first deep learning model configuration;
calculating a first result metric for the first deep learning model configuration;
selecting a first sample space, wherein the first sample space is based on the first deep learning model configuration;
generating a second deep learning model configuration, wherein the second deep learning model configuration is within the first sample space;
calculating a second result metric for the second deep learning model configuration;
in response to the second result metric exceeding the first result metric, selecting a second sample space, wherein the second sample space is based on the second deep learning model configuration; and
in response to the second result metric not exceeding the first result metric, reducing the size of the first sample space.

2. The computer-implemented method of claim 1, wherein the first deep learning model configuration comprises an ensemble comprising at least two learning model configurations.

3. The computer-implemented method of claim 1, wherein generating each of the first and second deep learning model configurations comprises at least one of:
generating a weight of an edge of a neural network model based on random number generation;
generating an edge connecting two nodes of the neural network model, wherein the position of the edge is based on random number generation;
generating a plurality of nodes of the neural network model, wherein the number of nodes is based on random number generation; and
generating a plurality of layers of the neural network model, wherein the number of layers is based on random number generation.

4. The computer-implemented method of claim 1, wherein calculating each of the first and second result metric comprises testing each of the first and second deep learning model configurations on a testing dataset.

5. The computer-implemented method of claim 4, wherein the first and second result metrics each comprise a metric based on at least one of:
testing dataset accuracy;
overfit; and
underfit.

6. The computer-implemented method of claim 1, wherein the first and second sample spaces each comprise a plurality of dimensions, wherein each dimension comprises a range of possible values for a parameter of a deep learning model configuration.

7. The computer-implemented method of claim 6, wherein a parameter of the deep learning model configuration comprises at least one of:
a weight of an edge of a neural network model;
a position of an edge of the neural network model;
a dropout node of the neural network model;
a configuration of a plurality of machine learning models of the deep learning model;
a number of layers of the neural network model; and
number of nodes in a layer of the neural network model.

8. The computer-implemented method of claim 1, wherein:
the first sample space being based on the first deep learning model configuration comprises the first sample space being centered on the first deep learning model configuration; and
the second sample space being based on the second deep learning model configuration comprises the second sample space being centered on the second deep learning model configuration.

9. The computer-implemented method of claim 1:
further comprising calculating an exploitation threshold; and
wherein selecting a first sample space comprises selecting the first sample space in response to the first result metric exceeding the exploitation threshold.

10. The computer-implemented method of claim 1, wherein the second result metric exceeding the first result metric comprises the second result metric exceeding the first result metric by a threshold amount, the threshold amount comprising an amount based on user configuration.

11. The computer-implemented method of claim 1, further comprising:
selecting a deep learning model configuration as an output deep learning model configuration;
calculating a third result metric, wherein the third result metric is based on additional training set data and the output deep learning model configuration;
in response to determining that the third result metric is below a threshold result metric, selecting a third sample space.

12. The computer-implemented method of claim 1, wherein:
generating the first deep learning model configuration comprises generating the first deep learning model using a first computational approach; and
generating the second deep learning model configuration comprises generating the second deep learning model using a second computational approach.

13. A computer-implemented method comprising:
generating a plurality of first deep learning model configurations; and
calculating a first result metric for each of the plurality of first deep learning model configurations;
selecting a deep learning model configuration from the plurality of first deep learning model configurations;
selecting a first sample space, wherein the first sample space is based on the selected first deep learning model configuration;
generating a plurality of second deep learning model configurations, wherein each second deep learning model configuration is within the first sample space;
calculating a second result metric for each second deep learning model configuration;
in response to the second result metric exceeding the first result metric, selecting a second sample space, wherein the second sample space is based on the second deep learning model configuration corresponding to the second result metric that exceeds the first result metric; and
in response to no result metric exceeding the first result metric, reducing the size of the first sample space.

14. The computer-implemented method of claim 13, wherein generating the plurality of first deep learning model configurations comprises generating a predetermined number of deep learning model configurations, wherein the predetermined number is based on a user-defined confidence interval.

15. The computer-implemented method of claim 13, wherein selecting the deep learning model configuration from the plurality of first deep learning model configurations comprises selecting the deep learning model configuration with a result metric above a predetermined threshold.

16. The computer-implemented method of claim 13, wherein:
generating the plurality of first deep learning model configurations comprises generating at least two of the first deep learning model configurations in parallel;
calculating the result first metric for each first deep learning model configuration comprises calculating at least two first result metrics in parallel; and
generating the plurality of second deep learning model configurations comprises generating at least two deep learning model configurations in parallel; and
calculating the result second metric for each first deep learning model configuration comprises calculating at least two second result metrics in parallel.

17. A computer-implemented method for improving a deep learning model configuration, comprising:
receiving a first deep learning model configuration;
calculating a first result metric for the first deep learning model configuration;
selecting a first sample space, wherein the first sample space is based on the first deep learning model configuration;
generating a second deep learning model configuration, wherein the second deep learning configuration is within the first sample space;
calculating a second result metric for the second deep learning configuration;
in response to the second result metric exceeding the first result metric, selecting a second sample space, wherein the second sample space is based on the second deep learning model configuration; and
in response to the second result metric not exceeding the first result metric, reducing the size of the first sample space.

18. The computer-implemented method of claim 17, wherein generating the second deep learning model configuration comprises adjusting a parameter of the deep learning model configuration.

19. The computer-implemented method of claim 18, wherein adjusting a parameter the first deep learning model configuration comprises at least one of:
adjusting a weight of an edge of a neural network of the first deep learning model configuration within a predetermined amount;
adding an edge to a neural network of the first deep learning model configuration; and
removing an edge from a neural network of the first deep learning model configuration.

20. The computer-implemented method of claim 18, wherein the first deep learning model configuration comprises an ensemble comprising a plurality of learning models, and adjusting a parameter of the first deep learning model configuration comprises at least one of:
removing a learning model from the ensemble; and
adding a learning model to the ensemble.
